(19) United States
(12) Patent Application Publication
(10) Pub. No.: US 2017/0254633 A1
(43) Pub. Date: Sep. 7, 2017

(54) PROXIMITY SENSOR

(71) Applicant: PANASONIC INTELLECTUAL PROPERTY MANAGEMENT CO., LT D., Osaka (JP)

(72) Inventors: Satoru TANAHASHI, Osaka (JP); Manabu INOUE, Osaka (JP); Kazushige TAKAGI, Osaka (JP); Hiroyuki KADO, Osaka (JP)

(21) Appl. No.: 15/299,121

(22) Filed: Oct. 20, 2016

(30) Foreign Application Priority Data
Mar. 7, 2016 (JP) 2016-042923
Oct. 17, 2016 (JP) 2016-203650

(51) Int. Cl. G01B 7/02; G01D 5/24

(52) U.S. Cl. CPC G01B 7/023; G01D 5/24; G06F 3/044

(57) ABSTRACT

A proximity sensor includes: a substrate; a first shield electrode disposed on a front surface of the substrate; a first detection electrode disposed on the front surface of the substrate, in a region surrounding the first shield electrode, the first detection electrode being electrically insulated from the first shield electrode and having an outer perimeter that is polygonal; a drive unit supplied with power, connected to the first shield electrode and the first detection electrode, and configured to apply voltage that equalizes an electric potential of the first shield electrode and an electric potential of the first detection electrode; and a detection unit configured to detect a change in capacitance in the first detection electrode.

### CROSS REFERENCE TO RELATED APPLICATION

This application claims the benefit of priority of Japanese Patent Application Number 2016-042923 filed on Mar. 7, 2016 and Japanese Patent Application Number 2016-203650 filed on Oct. 17, 2016, the entire contents of which are hereby incorporated by reference.

### BACKGROUND

1. Technical Field

The present disclosure relates to a proximity sensor that detects nearby objects, such as a person.

2. Description of the Related Art

WO 2004/059343 discloses a proximity sensor that detects objects by detecting a change in capacitance. The proximity sensor disclosed in WO 2004/059343 includes two detection electrodes and a ground electrode, which allows it to detect a target object with reduced influence from nearby non-target objects.

### SUMMARY

The present disclosure provides a proximity sensor that can be made compact and is capable of detecting a target object with reduced influence from nearby non-target objects.

In one aspect of the present disclosure, a proximity sensor includes: a substrate; a first shield electrode disposed on a front surface of the substrate; a first detection electrode disposed on the front surface of the substrate, in a region surrounding the first shield electrode, the first detection electrode being electrically insulated from the first shield electrode and having an outer perimeter that is polygonal; a drive unit supplied with power, connected to the first shield electrode and the first detection electrode, and configured to apply voltage that equalizes an electric potential of the first shield electrode and an electric potential of the first detection electrode; and a detection unit configured to detect a change in capacitance in the first detection electrode.

In another aspect of the present disclosure, a proximity sensor includes: a substrate; a first shield electrode disposed on a front surface of the substrate; a first detection electrode disposed on the front surface of the substrate, in a region surrounding the first shield electrode, the first detection electrode being electrically insulated from the first shield electrode; a second detection electrode disposed on the front surface of the substrate, inside a perimeter of the first detection electrode, the second detection electrode being electrically insulated from the first shield electrode and the first detection electrode; a drive unit supplied with power, connected to the first shield electrode, the first detection electrode, and the second detection electrode, and configured to apply voltage that equalizes an electric potential of the first shield electrode, an electric potential of the first detection electrode, and an electric potential of the second detection electrode; and a detection unit configured to detect a change in capacitance in the first detection electrode and the second detection electrode.

The proximity sensor according to the present disclosure can be made compact and is capable of detecting a target object with reduced influence from nearby non-target objects.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a block diagram of a proximity sensor according to Embodiment 1;

FIG. 2 illustrates external views of a sensor unit in the proximity sensor according to Embodiment 1;

FIG. 3 is a schematic diagram illustrating one example of a configuration of a detection unit in the proximity sensor illustrated in FIG. 1;

FIG. 4 illustrates a computation model for a sensor unit according to Example 1 of Embodiment 1;

FIG. 5 illustrates a computation model for a sensor unit according to Comparative Example 1 of Example 1;

FIG. 6 illustrates the results of the computations of the capacitances of the sensor units according to Example 1 and Comparative Example 1;

FIG. 7 illustrates a computation model for a sensor unit according to Example 2 of Embodiment 1;

FIG. 8 illustrates a comparative computation model for a sensor unit according to Comparative Example 2 of Example 2;

FIG. 9 illustrates the results of the computations of the capacitances of the sensor units according to Example 2 and Comparative Example 2;

FIG. 10 is a schematic diagram of a sensor unit in a proximity sensor according to Embodiment 2;

FIG. 11 is a schematic diagram illustrating one example of a configuration of a detection unit in the proximity sensor according to Embodiment 2;

FIG. 12 is a schematic diagram of a sensor unit in a proximity sensor according to Embodiment 3;

FIG. 13 is a schematic diagram illustrating one example of a configuration of a detection unit in the proximity sensor according to Embodiment 3; and

FIG. 14 is a schematic diagram illustrating an example of an application of the proximity sensor according to the present disclosure.

### DETAILED DESCRIPTION OF THE EMBODIMENTS

The inventors arrived at a proximity sensor that can be made compact and is capable of detecting a target object with reduced influence from nearby non-target objects in relation to the technique disclosed in the background section above, as follows.

In one aspect of the present disclosure, a proximity sensor includes: a substrate; a first shield electrode disposed on a front surface of the substrate; a first detection electrode disposed on the front surface of the substrate, in a region surrounding the first shield electrode, the first detection electrode being electrically insulated from the first shield electrode and having an outer perimeter that is polygonal; a drive unit supplied with power, connected to the first shield electrode and the first detection electrode, and configured to apply voltage that equalizes an electric potential of the first shield electrode and an electric potential of the first detection electrode; and a detection unit configured to detect a change in capacitance in the first detection electrode.

In the above configuration, since the first detection electrode is disposed in a region surrounding the first shield electrode, a predetermined capacitance can be ensured between the target object and the first detection electrode even when the overall size of the first detection electrode and the first shield electrode is small. Accordingly, a compact proximity sensor can be easily achieved. Moreover, by arranging the first detection electrode and the first shield electrode as above, the sensitivity to target objects can be increased and the sensitivity to matter contacting the surface, such as water droplets, can be decreased even when the overall size of the first detection electrode and the first shield electrode is small. Thus, a compact proximity sensor capable of detecting nearby target objects while inhibiting erroneous detection can be achieved.

In another aspect of the present disclosure, a proximity sensor includes: a substrate; a first shield electrode disposed on a front surface of the substrate; a first detection electrode disposed on the front surface of the substrate, in a region surrounding the first shield electrode, the first detection electrode being electrically insulated from the first shield electrode; a second detection electrode disposed on the front surface of the substrate, inside a perimeter of the first detection electrode, the second detection electrode being electrically insulated from the first shield electrode and the first detection electrode; a drive unit supplied with power, connected to the first shield electrode, the first detection electrode, and the second detection electrode, and configured to apply voltage that equalizes an electric potential of the first shield electrode, an electric potential of the first detection electrode, and an electric potential of the second detection electrode; and a detection unit configured to detect a change in capacitance in the first detection electrode and the second detection electrode.

In the above configuration, since the first and second detection electrodes and the first shield electrode are disposed as above and the first detection electrode is disposed in a region surrounding the first shield electrode, a compact proximity sensor capable of detecting nearby target objects while inhibiting erroneous detection can be achieved. Moreover, using the difference in amount of voltage change between the first detection electrode and the second detection electrode makes it possible to reduce the effect environmental noise resulting from, for example, electromagnetic waves has on the detection accuracy of the proximity sensor. As a result, the proximity sensor can operate stably.

The proximity sensor may further include a second shield electrode disposed on a rear surface of the substrate opposite the front surface of the substrate. In the above configuration, when a target object approaches the proximity sensor from the front surface side, the first detection electrode detects the nearby target object. When a target object approaches the proximity sensor from the rear surface side, the second shield electrode blocks the detection operation of the first detection electrode. As a result, the proximity sensor can limit the direction in which nearby target objects are detected.

Moreover, in a plan view of the front surface of the substrate, the second shield electrode may be configured not to extend beyond the outer perimeter of the first detection electrode. The above configuration inhibits the second shield electrode from reducing the capacitance that generates between the first detection electrode and the target object.

Moreover, the outer perimeter of the first detection electrode may be rectangular. According to the above configuration, the length of the outer perimeter of the first detection electrode can be longer than if the first detection electrode had, for example, a circle, ellipse, or oval shape. Thus, the sensitivity of the first detection electrode cab be increased and the overall size of the first detection electrode and the first shield electrode can be made to be more compact.

Moreover, the shield electrode may cover a region inside an inner perimeter of the detection electrode disposed in a region surrounding the shield electrode. According to the above embodiment, the surface area of the shield electrode can be increased. When matter, such as water droplets, is in contact with the surfaces of the shield electrode and the detection electrode, capacitance generates between the matter and the detection electrode. Among this capacitance, the capacitance of the large surface area shield electrode is dominant, making it possible to reduce sensitivity of the detection electrode to such matter.

The detection electrode may include one or more detection electrodes and the shield electrode may include one or more shield electrodes, and among the one or more detection electrodes and the one or more shield electrodes, an outermost electrode may be the detection electrode. In the above configuration, the outermost detection electrode is not surrounded by a shield electrode. Accordingly, limitation of the detection range of the outermost detection electrode by the shield electrode can be inhibited.

Moreover, the detection electrode may include a plurality of detection electrodes, and a shield electrode among the one or more shield electrodes may be disposed in a region surrounding a detection electrode among the plurality of detection electrodes. In the above configuration, a configuration including a detection electrode and a shield electrode disposed in a region surrounding the detection electrode is effective for detection when the distance between the detection electrode and the target object is sufficiently short. In contrast, a configuration including a shield electrode and a detection electrode disposed in a region surrounding the shield electrode is effective for detection when the distance between the detection electrode and the target object is sufficiently far. Accordingly, the proximity sensor is capable of effective compatibility with two types of detection.

Hereinafter, embodiments will be described with reference to the drawings. However, unnecessarily detailed descriptions may be omitted. For example, detailed descriptions of well-known matters or descriptions of elements that are substantially the same as elements described previous thereto may be omitted. This is to avoid unnecessary redundancy and provide descriptions that are easy to comprehend for those skilled in the art.

Note that the appended drawings and the following descriptions are provided to facilitate sufficient understanding of the present disclosure for those skilled in the art, and are not intended to limit the scope of the claims.

### Embodiment 1

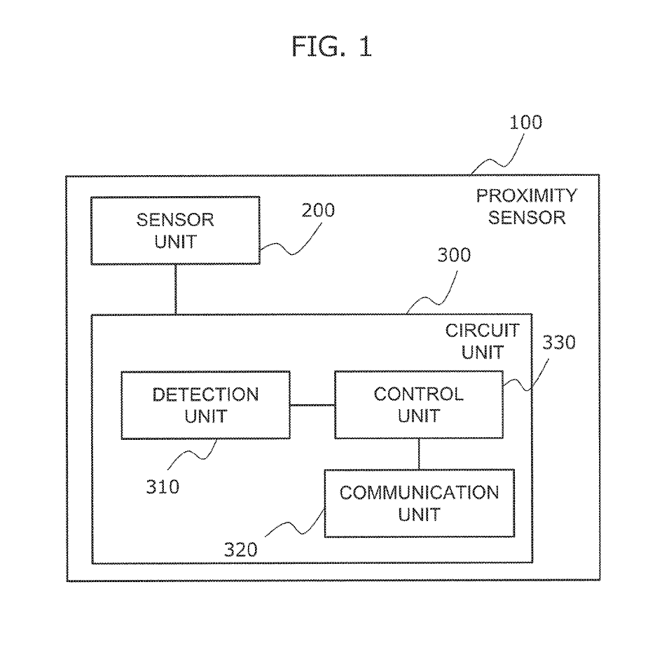

First, proximity sensor 100 according to Embodiment 1 will be described with reference to FIG. 1 through FIG. 7.

### 1-1. Configuration

First, the configuration of proximity sensor 100 according to Embodiment 1 will be described with reference to FIG. 1. FIG. 1 is a block diagram of proximity sensor 100 according to Embodiment 1. Proximity sensor 100 includes sensor unit 200 and circuit unit 300. Circuit unit 300 includes detection unit 310 that detects a signal from sensor unit 200, communication unit 320 for communicating with a device external to proximity sensor 100, and control unit 330 that controls detection unit 310 and communication unit 320.

Proximity sensor 100 is used for detecting nearby target objects, and has a variety of applications. Specific application examples for proximity sensor 100 will be given later.

Sensor unit 200 is a capacitive sensor, and will be described in detail later.

Detection unit 310 may be configured as circuitry, and may include, for example, a power supply, an electrical charge and discharge circuit, and a charge-to-voltage conversion circuit (C-V conversion circuit). Detection unit 310 applies voltage to sensor unit 200, detects a charge stored in sensor unit 200 resulting from a target object approaching sensor unit 200, and converts the charge into voltage. Here, detection unit 310 is one example of the drive unit and the detection unit.

Control unit 330 is exemplified as controlling detection unit 310 and communication unit 320, but control unit 330 may control the entire proximity sensor 100. Moreover, as will be described later, control unit 330 determines whether the voltage of sensor unit 200 detected by detection unit 310 exceeds a threshold. Control unit 330 may be circuitry such as a micro processing unit (MPU), central processing unit (CPU), or large scale integrated (LSI) circuit.

Communication unit 320 transmits the result of the determination by control unit 330 to an external device via radio communication such as wireless fidelity (Wi-Fi (registered trademark)). Communication unit 320 may be a communication circuit, for example.

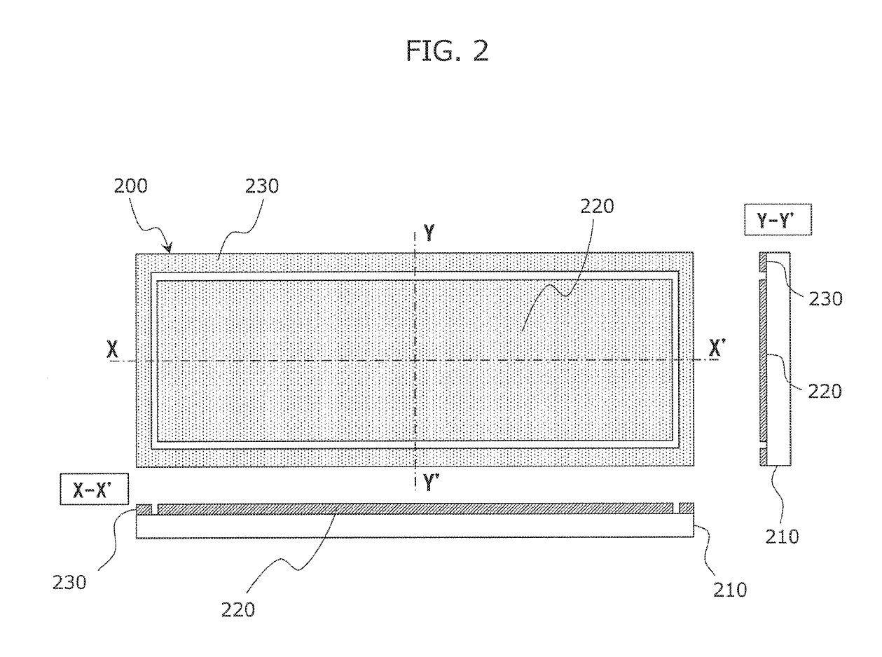

Next, sensor unit 200 will be described in detail with reference to FIG. 2. FIG. 2 illustrates external views of sensor unit 200 according to Embodiment 1. More specifically, FIG. 2 illustrates a plan view of sensor unit 200, a cross-section view of sensor unit 200 taken along line X-X′ extending along the longitudinal direction of sensor unit 200, and a cross-section view of sensor unit 200 taken along line Y-Y perpendicular to line X-X′. Sensor unit 200 is configured of circuitry including, for example, rigid printed circuit (RPC) boards and flexible printed circuit (FPC) boards. In this embodiment, sensor unit 200 has, but is not limited to, a rectangular shape in a plan view; sensor unit 200 may be any shape.

More specifically, sensor unit 200 includes insulating substrate 210 and an electrode pattern of first shield electrode 220 and first detection electrode 230 patterned on the front surface of insulating substrate 210. First shield electrode 220 and first detection electrode 230 are electrically connected to detection unit 310. In sensor unit 200, a charge is stored in first detection electrode 230 as a result of the electrical field of first detection electrode 230 being affected by a nearby target object. The detection of nearby target objects is possible due this stored charge. First shield electrode 220 reduces the effect objects near the target object have on detection accuracy based on the storage of the charge in first detection electrode 230. Here, insulating substrate 210 is one example of the substrate.

Insulating substrate 210 is made of an electrical insulator, such as epoxy resin, phenol resin, polyethylene terephthalate (PET), or polyethylene naphthalate (PEN). First shield electrode 220 and first detection electrode 230 are made of an electrical conductor, such as copper, aluminum, or indium tin oxide (ITO).

In a plan view of the front surface of insulating substrate 210, first shield electrode 220 has a polygonal shape (in this embodiment, a rectangular shape), and first detection electrode 230 is disposed outside the outer perimeter of the polygonal shape. First shield electrode 220 is disposed so as to cover a region inside the inner perimeter of first detection electrode 230. As such, first shield electrode 220 has a larger surface area than first detection electrode 230. Note that the polygonal shape may include, in addition to polygons, polygons whose corners have been rounded and polygons having curved sides, for example.

First detection electrode 230 has a frame-like shape with a polygonal outer perimeter (in this embodiment, a rectangular outer perimeter), and surrounds first shield electrode 220. Note that the polygonal shape may include, in addition to polygons, polygons whose corners have been rounded and polygons having curved sides, for example. First detection electrode 230 is evenly spaced from first shield electrode 220. More specifically, first detection electrode 230 is disposed such that there is a gap of a constant width between first shield electrode 220 and first detection electrode 230, and formed so as to have a constant width. This electrically insulates first detection electrode 230 from first shield electrode 220. The width of first detection electrode 230 refers to a width in a direction perpendicular to the outer edge. Moreover, first detection electrode 230 is disposed along the outer edge of insulating substrate 210. More specifically, as illustrated in the cross-section views in FIG. 2, the outer edge of first detection electrode 230 and the outer edge of insulating substrate 210 are essentially flush with each other—that is to say, are essentially coplanar. With this, restriction of the detection range, which is the range in which the electrical field of first detection electrode 230 can be affected by target objects, by insulating substrate 210 can be subdued. In other words, the restriction of the detection range of sensor unit 200 by insulating substrate 210 is subdued.

Regarding the dimensions of sensor unit 200 according to Embodiment 1, sensor unit 200 is approximately 25 mm×80 mm, the width of first detection electrode 230 is approximately 2 mm, the width of the gap between first detection electrode 230 and first shield electrode 220 is approximately 1 mm, first shield electrode 220 is approximately 19 mm×74 mm, and the thickness of insulating substrate 210 is approximately 1.5 mm to 3 mm, but the present disclosure is not limited to these examples. Note that the thickness of insulating substrate 210 refers to the thickness in a direction perpendicular to the front surface of insulating substrate 210 on which first shield electrode 220 and first detection electrode 230 are formed. As will be described later, the surface area that first shield electrode 220 occupies on the front surface of insulating substrate 210 is preferably greater than the surface area that first detection electrode 230 occupies on the front surface of insulating substrate 210.

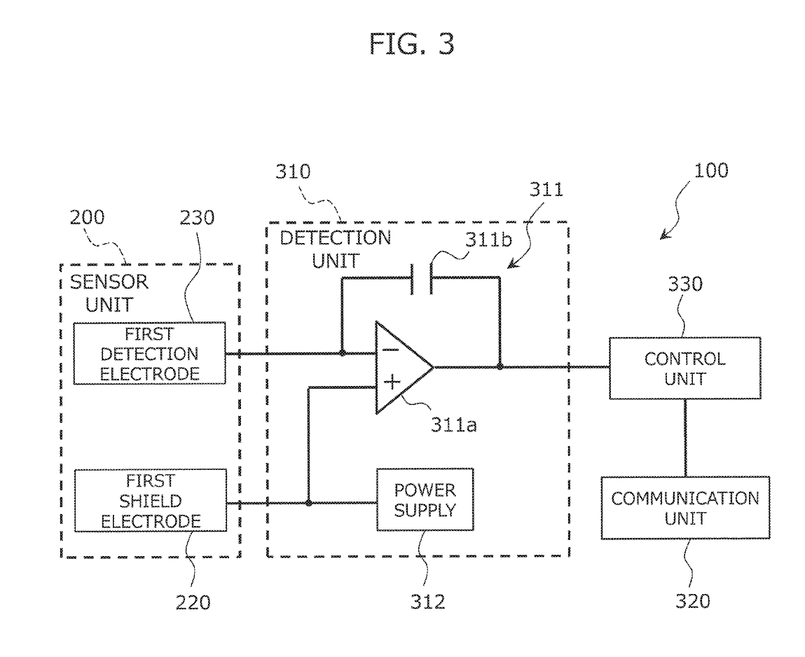

Moreover, with proximity sensor 100 according to this embodiment, detection unit 310 is configured to apply voltage that equalizes an electric potential of first shield electrode 220 and an electric potential of first detection electrode 230. Here, one example of detection unit 310 according to this embodiment that is configured to equalize the electric potential of first shield electrode 220 and first detection electrode 230 will be described with reference to FIG. 3. FIG. 3 is a schematic diagram illustrating one example of the configuration of detection unit 310 in proximity sensor 100 illustrated in FIG. 1.

Referring to FIG. 3, detection unit 310 includes charge-to-voltage conversion circuit (hereinafter referred to as “C-V conversion circuit”) 311 and power supply circuit 312. C-V conversion circuit 311 includes operational amplifier 311a and capacitor 311b. Power supply circuit 312 is connected to a non-inverting input terminal of operational amplifier 311a and first shield electrode 220. The inverting input terminal of operational amplifier 311a is connected to first detection electrode 230, and the output terminal of operational amplifier 311a is connected to control unit 330. Capacitor 311b is connected to the upstream electrical path of the inverting input terminal of operational amplifier 311a and the downstream electrical path of the output terminal of operational amplifier 311a. First detection electrode 230 may be grounded, and, alternatively, may not be grounded. In this embodiment, first detection electrode 230 is configured so as to not be applied with voltage by power supply circuit 312, and first shield electrode 220 is configured so as to be applied with voltage by power supply circuit 312.

With the above configuration, power supply circuit 312 applies voltage to first shield electrode 220 so as to equalize the electric potential of first shield electrode 220 with that of first detection electrode 230. In this state, when a target object approaches first detection electrode 230, the capacitance generated between the target object and first detection electrode 230 increases, causing a charge to be stored in first detection electrode 230. The charge stored in first detection electrode 230 is converted to voltage by C-V conversion circuit 311 and output to control unit 330. Note that an analog-to-digital converter (A/D converter) may be provided between the output terminal of operational amplifier 311a and control unit 330, and the A/D converter may be included in control unit 330. The A/D converter converts an analog signal of the voltage output from the output terminal of operational amplifier 311a into a digital signal.

### 1-2. Operation

Next, operations performed by proximity sensor 100 according to Embodiment 1 configured as described above will be described. Referring to FIG. 1 and FIG. 2, when proximity sensor 100 is ON, detection unit 310 applies voltage that equalizes the electric potential of first shield electrode 220 and the electric potential of first detection electrode 230. More specifically, detection unit 310 drives first shield electrode 220 so as to equalize the electric potential of first shield electrode 220 with that of first detection electrode 230.

In this state, when a target object approaches sensor unit 200, capacitance Ca is generated between the target object and first detection electrode 230 and capacitance Cs is generated between the target object and first shield electrode 220 as a result of the nearby target object. Note that capacitance Ca and capacitance Cs increase with decreasing distance between the target object and first detection electrode 230.

Detection unit 310 converts capacitance Ca to voltage Va. Control unit 330 determines whether voltage Va converted by detection unit 310 exceeds a predetermined threshold. When voltage Va exceeds the predetermined threshold, control unit 330 determines that a target object is in a predetermined proximity. Control unit 330 acknowledges the nearby target object based on the result of the determination.

Control unit 330 outputs the result of the acknowledgement to an external device via communication unit 320.

Note that since first shield electrode 220 and first detection electrode 230 are equal in electric potential, there is no charge and discharge between first shield electrode 220 and first detection electrode 230, and the apparent capacitance between first shield electrode 220 and first detection electrode 230 is equivalently zero. Consequently, changes in capacitance Cs do not affect capacitance Ca.

Next, the reasoning for configuring sensor unit 200 in the above manner will be described in detail. In general, with capacitive sensors, the capacitance generated between the detection electrode of the sensor and the target object is dependent on the surface area of the detection electrode when the distance between the detection electrode and the target object is sufficiently short. In contrast, when the distance between the detection electrode and the target object is sufficiently far, the fringe capacitance becomes dominant among the capacitance between the detection electrode and the target object. A sufficiently short distance between the detection electrode and the target object (distance d1) can be, for example, a distance that satisfies d1²<S, where S is the surface area of the detection electrode. Accordingly, when, for example, sensor unit 200 is approximately 25 mm×80 mm, as is the case in this embodiment, distance d1 can be less than 20 mm. Further, a sufficiently far distance between the detection electrode and the target object (distance d2) can be approximately 50 mm or longer.

The electrode pattern used in sensor unit 200 according to this embodiment makes use of these two properties. The advantages of the electrode pattern used in this embodiment regarding the detection of a target object by sensor unit 200—more specifically, detection when the distance between the detection electrode and the target object is sufficiently far—will be described using a computation model.

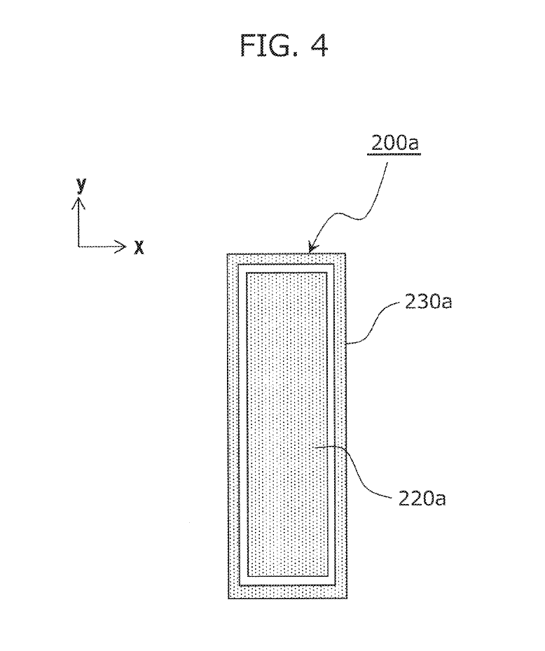

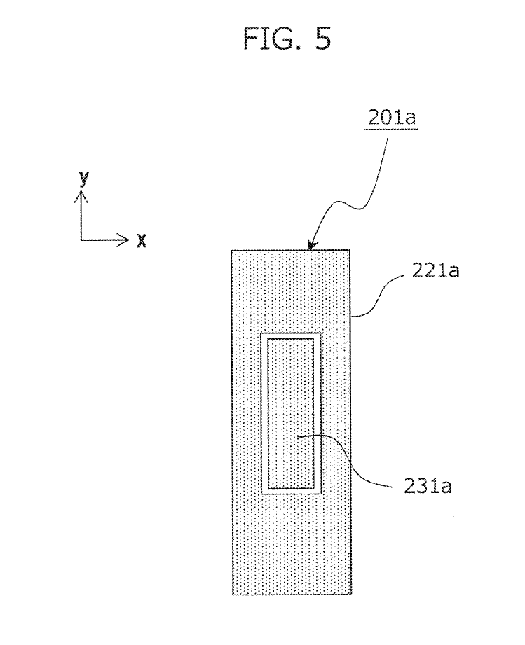

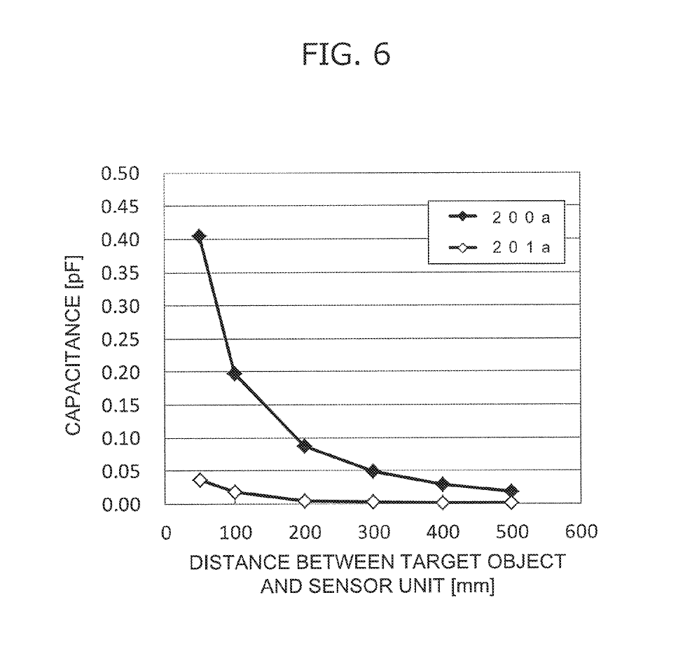

First, comparison results of capacitances produced between the first detection electrodes of two different sensor unit electrode patterns and a target object will be described with reference to FIG. 4 through FIG. 6. In this test, a sensor unit according to Example 1 of the present embodiment and a sensor unit according to Comparative Example 1 of Example 1 were compared. Example 1 is the electrode pattern described above in which first detection electrode is disposed outside the outer perimeter of the first shield electrode, and Comparative Example 1 is an electrode pattern in which the first shield electrode is disposed outside the outer perimeter of the first detection electrode. In the sensor units according to both Example 1 and Comparative Example 1, the surface area of first detection electrodes are the same, and the surface area of the first shield electrodes are the same. Note that FIG. 4 illustrates the computation model for sensor unit 200a according to Example 1 of Embodiment 1. FIG. 5 illustrates the computation model for sensor unit 201a according to Comparative Example 1 of Example 1. FIG. 6 illustrates the results of the computations of the capacitances of the sensor units according to Example 1 and Comparative Example 1.

Referring to FIG. 4, sensor unit 200a according to Example 1 is formed to have an electrode pattern in which first detection electrode 230a is disposed outside the outer perimeter of first shield electrode 220a. Here, in FIG. 4, the longitudinal direction of the rectangular sensor unit 200a corresponds to the y axis, and the transverse direction of sensor unit 200a corresponds to the x axis which is perpendicular to the y axis. This also applies to all figures after FIG. 4.

Here, the length of the outer perimeter of first detection electrode 230a along the x axis is 25 mm, the length of the outer perimeter of first detection electrode 230a along the y axis is 80 mm, and the width of first detection electrode 230a is 2 mm. The length of first shield electrode 220a along the x axis is 19 mm, and the length of first shield electrode 220a along the y axis is 74 mm. The width of the gap between first detection electrode 230a and first shield electrode 220a is 1 mm.

In contrast, referring to FIG. 5, sensor unit 201a according to Comparative Example 1 is formed to have an electrode pattern in which first detection electrode 231a is disposed inside the perimeter of first shield electrode 221a. The length of first detection electrode 231a along the x axis is 10 mm, and the length of first detection electrode 231a along the y axis is 40.4 mm. The length of the outer perimeter of first shield electrode 221a along the x axis is 25 mm, and the length of the outer perimeter of first shield electrode 221a along the y axis is 80 mm. The width of the gap between first detection electrode 231a and first shield electrode 221a is 1 mm.

The result of the comparison of the capacitances resulting from the electrode patterns of Example 1 and Comparative Example 1 is shown in FIG. 6. FIG. 6 is a graph in which the results of the computations are plotted. The distance between the target object and the sensor unit is represented on the horizontal axis, and the capacitance between the target object and the first detection electrode is represented on the vertical axis.

As illustrated in FIG. 6, the configuration of the electrode pattern of sensor unit 200a in which first detection electrode 230a is disposed on the outside (Example 1) yields a greater capacitance than the configuration of the electrode pattern of sensor unit 201a in which first shield electrode 221a is disposed on the outside (Comparative Example 1). When the distance is 50 mm in particular, the results show that the capacitance in sensor unit 200a is approximately 10 times the capacitance in sensor unit 201a. Since the configuration in which the detection electrode is disposed outside the outer perimeter of the shield electrode can effectively use fringe capacitance as capacitance more so than the opposite configuration, capacitance can be increased, thereby improving the sensitivity of the sensor unit.

Moreover, in the configuration in which first detection electrode 230a is disposed outside the outer perimeter of first shield electrode 220a, since nothing surrounds first detection electrode 230a, first detection electrode 230a has a large detection range. In contrast, in the configuration in which first detection electrode 231a is disposed inside the perimeter of first shield electrode 221a, since first detection electrode 231a is surrounded by first shield electrode 221a, first detection electrode 231a has a narrow detection range. For example, in the case of the former configuration, first detection electrode 230a has a detection range including directions forward, out of the sides, and backward. The forward direction is a direction perpendicular to insulating substrate 210. In the case of the later configuration, first detection electrode 231a has a detection range that is limited to the forward direction perpendicular to insulating substrate 210.

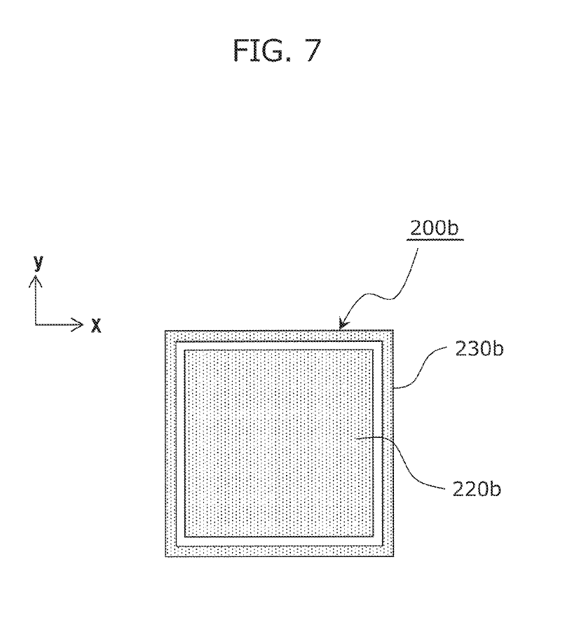

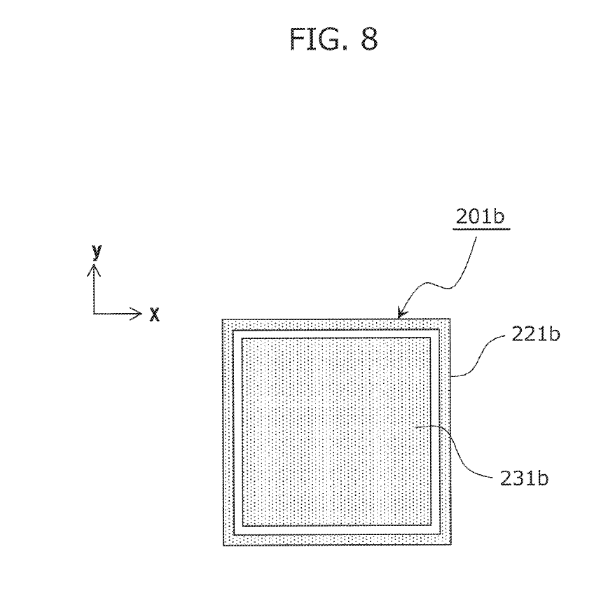

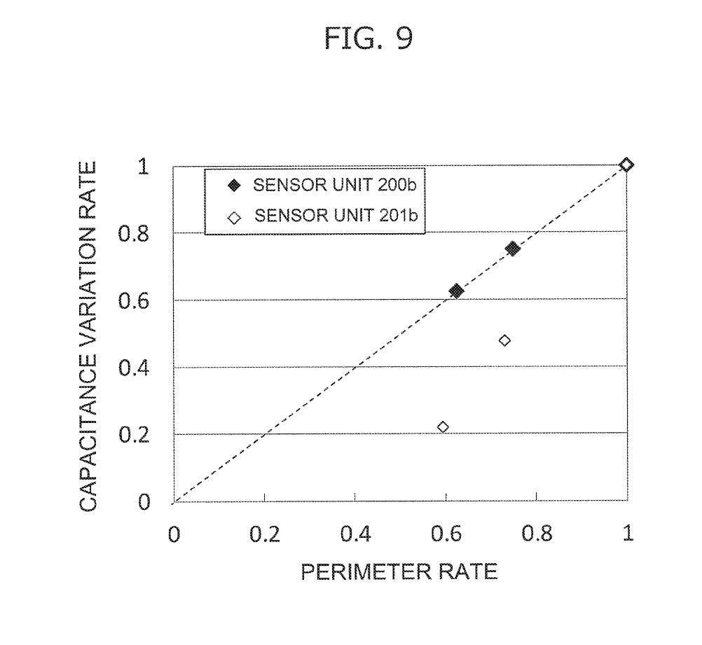

Next, comparison results of capacitances produced between the first detection electrode and a target object when the size of the sensor unit is changed relative to Example 1 and Comparative Example 1 will be described with reference to FIG. 7 through FIG. 9. In this test, Example 2 in which the size of sensor unit 200a according to Example 1 was changed and Comparative Example 2 in which the size of sensor unit 201a according to Comparative Example 1 was changed were compared. FIG. 7 illustrates the computation model for sensor unit 200b according to Example 2 of Embodiment 1. FIG. 8 illustrates the computation model for sensor unit 201b according to Comparative Example 2 of Example 2. FIG. 9 illustrates the results of the computations of the capacitances of the sensor units according to Example 2 and Comparative Example 2.

Referring to FIG. 7, sensor unit 200b according to Example 2 is formed to have an electrode pattern in which first detection electrode 230b is disposed to surround the outer perimeter of first shield electrode 220b. Referring to FIG. 8, sensor unit 201b according to Comparative Example 2 is formed to have an electrode pattern in which first shield electrode 221b is disposed to surround the outer perimeter of first detection electrode 231b.

Here, as illustrated in FIG. 7, in sensor unit 200b according to Example 2, the outer length of each side of first detection electrode 230b along the x and y axes is 80 mm, and the width of first detection electrode 230b is 2 mm. The length of each side of first shield electrode 220b along the x and y axes is 74 mm, and the width of the gap between first detection electrode 230b and first shield electrode 220b is 1 mm.

Moreover, as illustrated in FIG. 8, in sensor unit 201b according to Comparative Example 2, the arrangement of first detection electrode 231b and first shield electrode 221b are opposite that of sensor unit 200b according to Example 2. In other words, the outer length of each side of first shield electrode 221b along the x and y axes is 80 mm, and the width of first shield electrode 221b is 2 mm. The length of each side of first detection electrode 231b along the x and y axes is 74 mm, and the width of the gap between first detection electrode 231b and first shield electrode 221b is 1 mm.

The graph in FIG. 9 illustrates computation results showing the relationship between size variation rate and capacitance variation rate when the overall size of electrode patterns of sensor unit 200b and sensor unit 201b illustrated in FIG. 7 and FIG. 8 are decreased. Note that in FIG. 9, the rate of the length of the outer perimeter of the sensor unit is represented on the horizontal axis, and the capacitance variation rate between the target object and the first detection electrode is represented on the vertical axis. The outer perimeter length rate and the capacitance variation rate are reduced rates of the outer perimeter length and capacitance of sensor unit 200b and sensor unit 201b having the dimensions described above with relation to FIG. 7 and FIG. 8. Furthermore, the capacitance is measured when the distance between the target object and the sensor unit is 500 mm.

The tests were performed when the dimensions of the outer perimeter of the sensor unit were reduced to one half size along the x axis (x axis length of 40 mm, outer perimeter length rate of 0.75) and to one fourth size along the x axis (x axis length of 20 mm, outer perimeter length rate of 0.625). As a result, compared to the configuration in which first shield electrode 221b is disposed on the outside (Comparative Example 2), with the configuration in which first detection electrode 230b is disposed on the outside (Example 2), there is less of a decrease in capacitance in accordance with the reduction in size, as illustrated in FIG. 9. In other words, disposing the first detection electrode on the outside makes it possible to inhibit a reduction in sensor unit sensitivity even when the overall size of the sensor unit is reduced.

Therefore, according to the results in FIG. 6 and FIG. 9, the configuration in which the detection electrode is disposed outside the outer perimeter of the shield electrode can ensure a certain level of sensitivity, with respect to the target object, that allows for sensor unit 200 to be made smaller compared to the opposite configuration.

Note that, as described above, when detecting a target object, since the fringe capacitance greatly affects the capacitance, in order to achieve a compact sensor unit 200, there is a need to reduce the surface area of sensor unit 200 as well as increase the length of the outer perimeter. Thus, sensor unit 200 preferably has, in a plan view, a polygonal shape rather than a circular, elliptical, oval shape, and in particular preferably has a rectangular shape, as is the case in this embodiment.

Moreover, there may be times when matter contacts the surface of sensor unit 200, such as water droplets in the form of, for example, rain, snow, or dew. In this case, such matter generates a capacitance between the matter and the detection electrode that corresponds to when the distance between the detection electrode and the target object is sufficiently short. Consequently, this capacitance is dependent on the surface area of the detection electrode and the shield electrode.

Here, among the capacitance generated in sensor unit 200 by the matter contacting the surface, such as water droplets, the capacitance of a large surface area first shield electrode 220 is dominant, and the capacitance of a small surface area first detection electrode 230 is small. As a result, the sensitivity of sensor unit 200 to such matter can be decreased. Accordingly, the surface area of first shield electrode 220 is preferably larger than the surface area of first detection electrode 230.

### 1-3 Advantageous Effects, Etc.

As described above, with proximity sensor 100 according to this embodiment, since first detection electrode 230 is disposed outside the outer perimeter of first shield electrode 220—that is to say, disposed in a region surrounding first shield electrode 220—a predetermined capacitance can be ensured even if the overall size of sensor unit 200 determined by first detection electrode 230 and first shield electrode 220 is small. Accordingly, a compact proximity sensor 100 can be easily achieved.

Moreover, by arranging first detection electrode 230 and first shield electrode 220 as above, even if sensor unit 200 is small in size, the sensitivity of sensor unit 200 to target objects can be increased and the sensitivity to matter contacting the surface, such as water droplets, can be decreased. Thus, proximity sensor 100 makes it possible to achieve a compact capacitive sensor capable of detecting nearby target objects while inhibiting erroneous detection.

### Embodiment 2

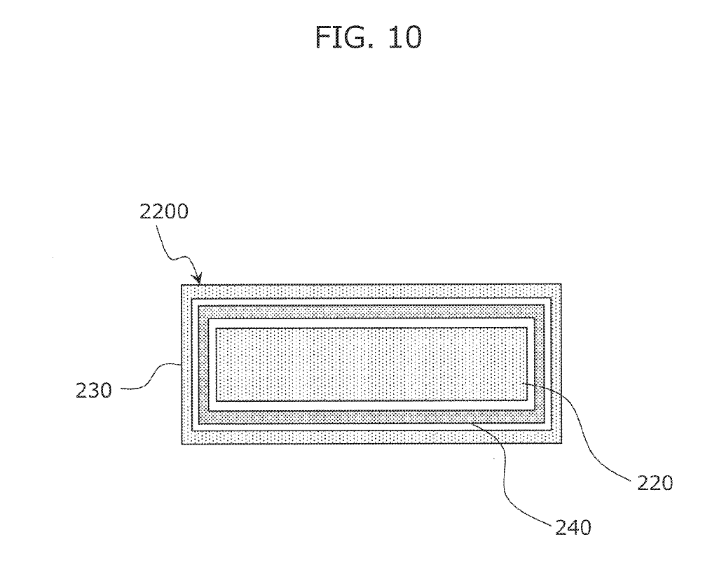

Hereinafter, a proximity sensor according to Embodiment 2 will be described with reference to FIG. 10. In the proximity sensor according to Embodiment 2, the configuration of the sensor unit is different from sensor unit 200 according to Embodiment 1, but all other configurations are the same as Embodiment 1. As such, descriptions of configurations which are the same as in Embodiment 1 will be omitted.

### 2-1. Configuration

FIG. 10 is a schematic diagram of sensor unit 2200 in the proximity sensor according to Embodiment 2. The configuration of sensor unit 2200 in the proximity sensor according to Embodiment 2 is equivalent to a configuration in which sensor unit 200 according to Embodiment 1 further includes second detection electrode 240 disposed inside the perimeter of first detection electrode 230. More specifically, second detection electrode 240 is formed between first detection electrode 230 and first shield electrode 220, and is formed in a frame-like shape that surrounds the outer perimeter of first shield electrode 220. Second detection electrode 240 is disposed such that there is a gap of a constant width between first detection electrode 230 and second detection electrode 240, and a gap of a constant width between first shield electrode 220 and second detection electrode 240, and is formed so as to have a constant width. With this, second detection electrode 240 is electrically insulated from first detection electrode 230 and first shield electrode 220. Second detection electrode 240 is electrically connected to detection unit 310.

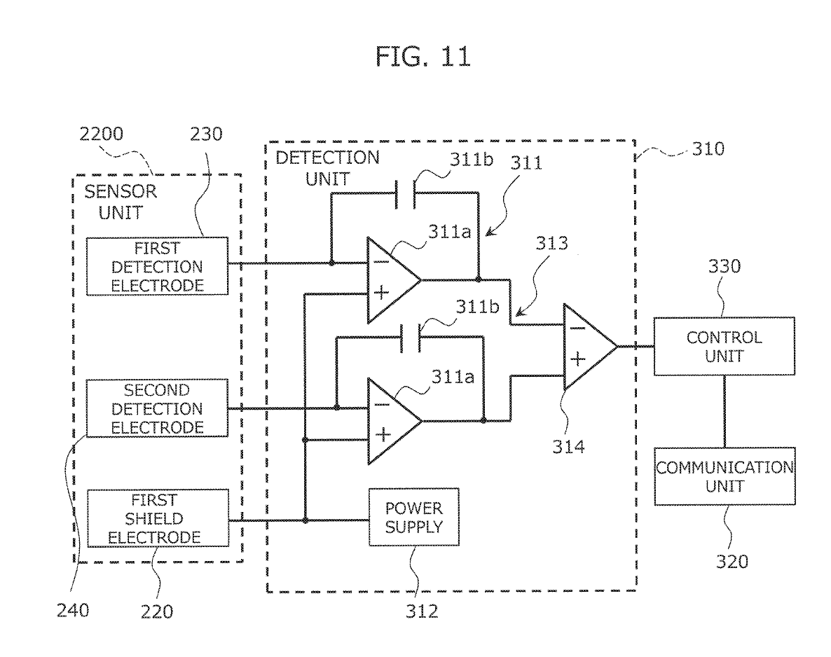

Detection unit 310 applies voltage that equalizes the electric potential of first detection electrode 230, second detection electrode 240, and first shield electrode 220 having the configuration described above. Here, one example of detection unit 310 according to this embodiment that is configured to equalize the electric potential of first detection electrode 230, second detection electrode 240, and first shield electrode 220 will be described with reference to FIG. 11. FIG. 11 is a schematic diagram illustrating one example of a configuration of detection unit 310 in the proximity sensor according to Embodiment 2.

Referring to FIG. 11, detection unit 310 includes first C-V conversion circuit 311, second C-V conversion circuit 313, operational amplifier 314, and power supply circuit 312. First C-V conversion circuit 311 and second C-V conversion circuit 313 both include operational amplifier 311a and capacitor 311b. Power supply circuit 312 is connected to first shield electrode 220. Power supply circuit 312 is further connected to non-inverting input terminals of operational amplifiers 311a in first C-V conversion circuit 311 and second C-V conversion circuit 313. The inverting input terminal of operational amplifier 311a in first C-V conversion circuit 311 is connected to first detection electrode 230, and the output terminal of the same operational amplifier 311a is connected to the inverting input terminal of operational amplifier 314. The inverting input terminal of operational amplifier 311a in second C-V conversion circuit 313 is connected to second detection electrode 240, and the output terminal of the same operational amplifier 311a is connected to the non-inverting input terminal of operational amplifier 314. The output terminal of operational amplifier 314 is connected to control unit 330. Capacitor 311b of first C-V conversion circuit 311 is connected upstream the inverting input terminal of operational amplifier 311a of first C-V conversion circuit 311 and downstream the output terminal of the same operational amplifier 311a. Capacitor 311b of second C-V conversion circuit 313 is connected upstream the inverting input terminal of operational amplifier 311a of second C-V conversion circuit 313 and downstream the output terminal of the same operational amplifier 311a. First detection electrode 230 and second detection electrode 240 may be grounded, and, alternatively, may not be grounded. In this embodiment, first detection electrode 230 and second detection electrode 240 are configured so as to not be applied with voltage by power supply circuit 312, and first shield electrode 220 is configured so as to be applied with voltage by power supply circuit 312.

With the above configuration, power supply circuit 312 applies voltage to first shield electrode 220 so as to equalize the electric potential of first shield electrode 220 with that of first detection electrode 230 and second detection electrode 240. With this, the electric potential of first detection electrode 230, second detection electrode 240, and first shield electrode 220 is equalized. In this state, when a target object approaches first detection electrode 230 and second detection electrode 240, the capacitance generated between the target object and first detection electrode 230 and second detection electrode 240 increases, causing a charge to be stored in first detection electrode 230 and second detection electrode 240. The charge stored in first detection electrode 230 is converted to voltage by first C-V conversion circuit 311 and output to control unit 330. The charge stored in second detection electrode 240 is converted to voltage by second C-V conversion circuit 313 and output to control unit 330. Note that an A/D converter may be provided between the output terminal of operational amplifier 314 and control unit 330, and the A/D converter may be included in control unit 330.

### 2-2. Operation

Next, operations performed by the proximity sensor according to Embodiment 2 configured as described above will be described. Referring to FIG. 1 and FIG. 10, when the proximity sensor is ON, detection unit 310 applies voltage that equalizes the electric potential of first shield electrode 220, first detection electrode 230, and second detection electrode 240.

In this state, when a target object approaches sensor unit 2200 in the proximity sensor, capacitance Ca is generated between the target object and first detection electrode 230 and capacitance Cb is generated between the target object and second detection electrode 240 as a result of the nearby target object. Note that capacitance Ca and capacitance Cb increase with decreasing distance between the target object and first detection electrode 230 and second detection electrode 240.

Detection unit 310 converts capacitance Ca to voltage Va and capacitance Cb to voltage Vb. Control unit 330 determines whether the difference between voltage Va and voltage Vb—more specifically, the absolute value of Va−Vb—converted by detection unit 310 exceeds a predetermined threshold. When the difference in voltage exceeds the predetermined threshold, control unit 330 determines that a target object is in a predetermined proximity. Control unit 330 acknowledges the nearby target object based on the result of the determination.

Note that since first detection electrode 230 is disposed outside the outer perimeter of second detection electrode 240, when it is determined that a target object is nearby, Ca>Cb. As such, the difference in voltage can be calculated by subtracting voltage Vb of second detection electrode 240 from voltage Va of first detection electrode 230.

Control unit 330 outputs the result of the acknowledgement to an external device via communication unit 320.

Note that since first detection electrode 230, second detection electrode 240, and first shield electrode 220 are equal in electric potential, there is no charge and discharge between the electrodes, and the apparent capacitances between the electrodes are equivalently zero. Consequently, changes in one capacitance do not affect the other.

Note that similar to first shield electrode 220 according to Embodiment 1, regarding the effect matter contacting the surface, such as water droplets, has on sensor unit 2200, sensitivity to matter contacting the surfaces of first detection electrode 230 and second detection electrode 240 is decreased by first shield electrode 220 according to this embodiment.

### 2-3 Advantageous Effects, Etc.

As described above, with the proximity sensor according to Embodiment 2, since first detection electrode 230 is disposed outside the outer perimeter of first shield electrode 220, a predetermined capacitance can be ensured even if the overall size of sensor unit 2200 determined by first detection electrode 230, second detection electrode 240, and first shield electrode 220 is small. Accordingly, a compact proximity sensor can be easily achieved.

Moreover, by arranging the detection electrode and the shield electrode as above, even if sensor unit 2200 is small in size, the sensitivity of sensor unit 2200 to target objects can be increased and the sensitivity to matter contacting the surface, such as water droplets, can be decreased. Thus, the proximity sensor makes it possible to achieve a compact capacitive sensor capable of detecting nearby target objects while inhibiting erroneous detection.

Moreover, using the difference in amount of voltage change between first detection electrode 230 and second detection electrode 240 makes it possible to reduce the effect environmental noise resulting from electromagnetic waves from, for example, the switching of lights or wireless sources, has on the detection accuracy of sensor unit 2200. More specifically, the difference in the amount of voltage change cancels out environmental noise. As a result, the proximity sensor can operate more stably.

### Embodiment 3

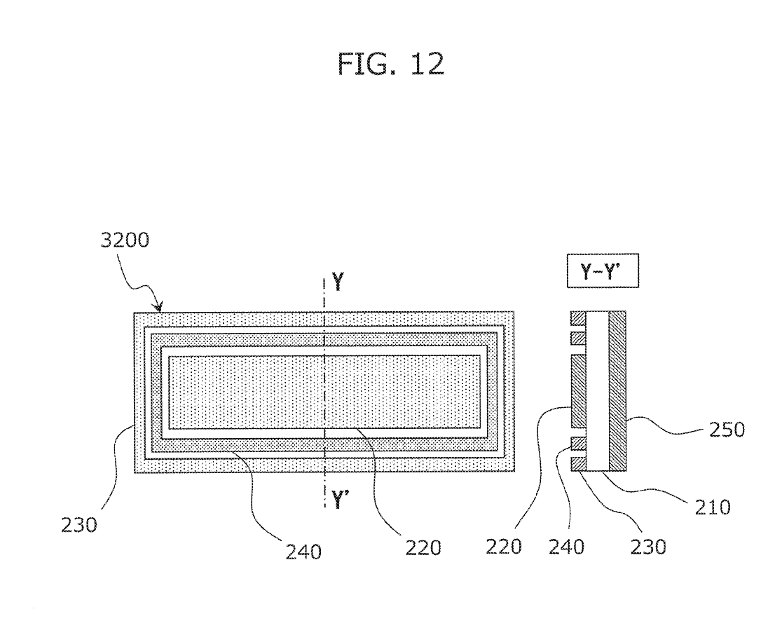

Hereinafter, a proximity sensor according to Embodiment 3 will be described with reference to FIG. 12. In the proximity sensor according to Embodiment 3, the configuration of the sensor unit is equivalent to a configuration in which sensor unit 2200 according to Embodiment 2 further includes a shield electrode on the rear surface of the insulating substrate; all other points are the same as Embodiment 2. As such, descriptions of configurations which are the same as in Embodiment 2 will be omitted.

### 3-1. Configuration

FIG. 12 is a schematic diagram of sensor unit 3200 in the proximity sensor according to Embodiment 3. FIG. 12 illustrates a plan view of sensor unit 3200 and a cross-section view of sensor unit 3200 taken along line Y-Y′ extending along the transverse direction of the rectangular sensor unit 3200. As illustrated in FIG. 12, in sensor unit 3200, first shield electrode 220, first detection electrode 230, and second detection electrode 240 are disposed on the front surface of insulating substrate 210, and second shield electrode 250 is disposed on the opposite, rear surface of insulating substrate 210.

Note that the outer edge of second shield electrode 250 is, in a plan view of the front surface of insulating substrate 210, in the same position as the outer edge of first detection electrode 230 as illustrated in the cross-section view in FIG. 12, or is positioned further inward than the outer edge of first detection electrode 230. In other words, in a plan view of insulating substrate 210, the outer edge of second shield electrode 250 does not extend beyond the outer edge of first detection electrode 230. Further, the outer edge of second shield electrode 250 is, in a plan view of the front surface of insulating substrate 210, in the same position as the outer edge of insulating substrate 210, or is positioned further inward than the outer edge of insulating substrate 210.

Next, the reasoning for adopting a configuration in which, in a plan view, the outer edge of second shield electrode 250 does not extend beyond the outer edge of first detection electrode 230 will be described. As described above, when the distance between the detection electrode and the target object is sufficiently far, the fringe capacitance becomes dominant among the capacitance between the detection electrode and the target object. As such, if the outer edge of second shield electrode 250 were to extend beyond the outer edge of first detection electrode 230, second shield electrode 250 would cause the capacitance of first detection electrode 230 to decrease. Therefore, to reduce this effect on first detection electrode, the outer edge of second shield electrode 250 is not configured to extend beyond the outer edge of first detection electrode 230.

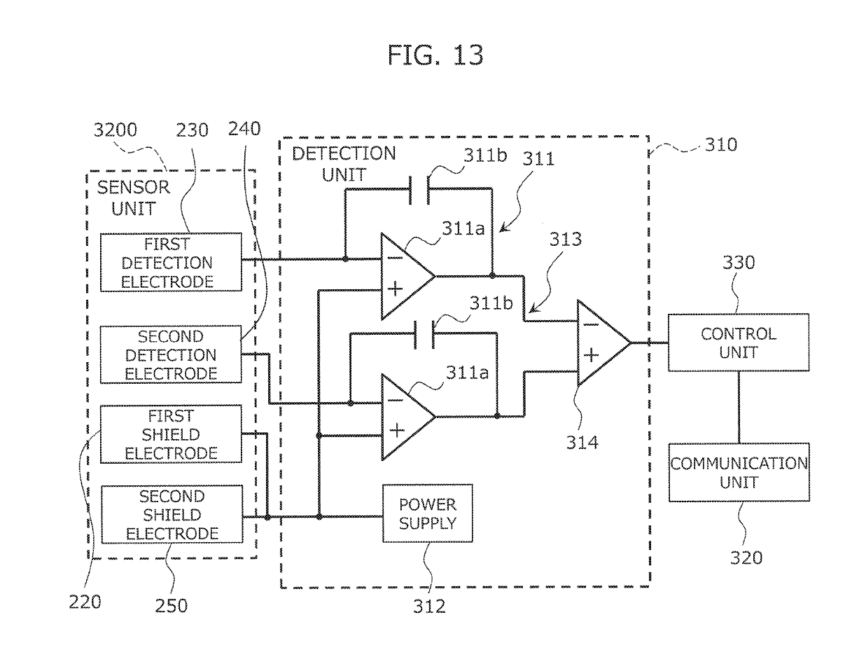

Second shield electrode 250 configured as described above is connected to detection unit 310 illustrated in FIG. 1. Voltage having the same electric potential as first shield electrode 220, first detection electrode 230, and second detection electrode 240 is applied to second shield electrode 250 by detection unit 310. Here, one example of detection unit 310 according to this embodiment that is configured to equalize the electric potential of second shield electrode 250, first shield electrode 220, first detection electrode 230, and second detection electrode 240 will be described with reference to FIG. 13. FIG. 13 is a schematic diagram of one configuration example of detection unit 310 in the proximity sensor according to Embodiment 3.

Referring to FIG. 13, excluding that power supply circuit 312 is connected to second shield electrode 250 in addition to first shield electrode 220, detection unit 310 has the same configuration as in FIG. 11. Thus, in this embodiment, first detection electrode 230 and second detection electrode 240 are configured so as to not be applied with voltage by power supply circuit 312, and first shield electrode 220 and second shield electrode 250 are configured so as to be applied with voltage by power supply circuit 312. Power supply circuit 312 is configured to apply voltage to first shield electrode 220 and second shield electrode 250 so as to equalize the electric potential of first detection electrode 230, second detection electrode 240, first shield electrode 220, and second shield electrode 250. Other configurations of detection unit 310 are the same as detection unit 310 illustrated in FIG. 11.

### 3-2. Operation

Next, operations performed by the proximity sensor according to Embodiment 3 configured as described above will be described. When a target object approaches sensor unit 3200 of the proximity sensor, while the proximity sensor is ON, from the side on which first detection electrode 230 is formed, the proximity sensor operates in the same manner as Embodiment 1 and Embodiment 2. However, when a target object approaches sensor unit 3200 of the proximity sensor from the rear surface on which second shield electrode 250 is formed, which is opposite the side on which first detection electrode 230 is formed, second shield electrode 250 blocks the detection operation by first detection electrode 230 and second detection electrode 240 since the electric potential of first detection electrode 230, the electric potential of second detection electrode 240, and the electric potential of second shield electrode 250 are equal. More specifically, second shield electrode 250 blocks the effect the target object has on the electrical field of first detection electrode 230 and second detection electrode 240. This prevents capacitance from being generated between the target object and first detection electrode 230 and second detection electrode 240 and thus prevents the proximity sensor from detecting nearby target objects. Thus, the proximity sensor according to this embodiment is capable of limiting the direction in which nearby target objects are detected.

### 3-3 Advantageous Effects, Etc.

As described above, similar to the proximity sensors according to Embodiment 1 and Embodiment 2, the proximity sensor according to Embodiment 3 can detect nearby target objects and can further limit the direction in which nearby objects are detected. Note that incorporating the second shield electrode into proximity sensor 100 according to Embodiment 1 yields the same advantageous effects.

More specifically, the configuration of sensor unit 3200 in the proximity sensor according to Embodiment 3 is equivalent to a configuration in which sensor unit 2200 according to Embodiment 2 further includes a second shield electrode formed on the rear surface opposite the front surface on which first detection electrode 230 is formed. However, the sensor unit may be formed by disposing a second shield electrode on the rear surface opposite the front surface on which first detection electrode 230 is formed in sensor unit 200 according to Embodiment 1.

### Other Embodiments

Hereinbefore, Embodiments 1 through 3 have been given as examples of the techniques disclosed in the present application. However, the techniques disclosed in the present application are not limited to these examples; various modifications, replacements, additions and omissions are possible. Moreover, each element described in the above embodiments and other embodiments to be described below may be combined to achieve new embodiments. Next, other embodiments will be described.

With the proximity sensors according to Embodiments 1 to 3, the detection electrode and the shield electrode in the sensor unit are each configured as a single continuous electrode, but each may be configured of a plurality of electrodes. For example, each electrode in the sensor unit may be split into a plurality of electrodes. For example, first detection electrode 230 may be split into four electrodes, and the four electrodes may be disposed so as to surround the four sides of first shield electrode 220.

With the sensor units in the proximity sensors according to Embodiments 1 to 3, the detection electrode is disposed outside the outer perimeter of the shield electrode; but this example is not limiting. The shield electrode may be disposed in a region surrounding the outside of the detection electrode. In this case, it is preferable that two or more detection electrodes are provided. Further, the outermost electrode is preferably a detection electrode. A configuration including a shield electrode and a detection electrode disposed inside the inner perimeter of the shield electrode is effective for detection when the distance between the detection electrode and the target object is sufficiently short. A configuration including a shield electrode and a detection electrode disposed outside the outer perimeter of the shield electrode is effective for detection when the distance between the detection electrode and the target object is sufficiently far. Thus, a configuration in which detection electrodes are disposed outside and inside the perimeter of the shield electrode is effectively adapted to both detection when the distance between the detection electrode and the target object is sufficiently short and detection when the distance between the detection electrode and the target object is sufficiently far. Further, in the later case, since the outermost electrode is a detection electrode, limitation of the detection range of the detection electrode by the shield electrode can be inhibited.

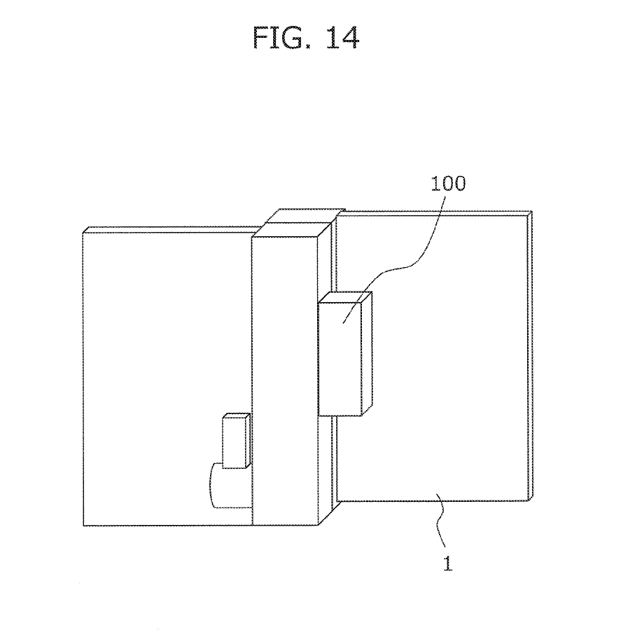

Moreover, the proximity sensors according to Embodiments 1 to 3 can be applied as follows. For example, as illustrated in FIG. 14, proximity sensor 100 is applicable as a window sensor by attaching proximity sensor 100 to window 1 of a building and configuring proximity sensor 100 to communicate with a security system installed in the building.

In this case, the target object is a person. More specifically, when a person approaches proximity sensor 100, capacitance is generated in proximity sensor 100. A predetermined threshold for such a capacitance is set in proximity sensor 100. When the capacitance exceeds the threshold, proximity sensor 100 determines that a person is nearby.

Accordingly, proximity sensor 100 can detect that a person is nearby window 1 before window 1 is opened or closed or broken, for example. Proximity sensor 100 is applicable in security applications for preventing abnormalities, such as window 1 being opened, closed, or broken, from occurring rather than for detecting the occurrence of such abnormalities.

Note that when proximity sensor 100 is used as a window sensor, proximity sensor 100 preferably detects only people outside the building and not people inside the building. In this case, the proximity sensor according to Embodiment 3 that is capable of limiting the direction in which target objects are detected is particularly applicable.

Moreover, in the proximity sensors according to Embodiment 1 to 3, the first shield electrode of the sensor unit may be formed in a frame-like shape. With this, devices, such as a liquid crystal panel, organic or inorganic electroluminescent (EL) display device, and touch sensor, can be disposed within the frame of the first shield electrode.

Using the proximity sensor configured as described above, a configuration capable of turning on and off the power of a device within the frame of the first shield electrode, such as a touch sensor and/or display device, can be realized. Further, a configuration in which the detection electrode is split into a plurality of detection electrodes and each of the electrodes performs detection independently may be used. In other words, the plurality of split detection electrodes form a plurality of sensor units. With this, the proximity sensor can detect, for example, gestures made by a person, and a device including such a proximity sensor is applicable as a device that receives gesture inputs, for example.

Moreover, the proximity sensors according to Embodiment 1 to 3 are applicable in various uses and places other than those described above. For example, the proximity sensor may be placed on the floor or a wall to count people passing by the sensor. For example, the proximity sensor may be placed on, for example, a fence to alert outsiders from entering a predetermined area.

Moreover, for example, the proximity sensor may be placed under a bed or futon, for example, and used for medical examination purposes, such as to detect when a person leaves the bed or turns over in his or her sleep, or check a person's pulse.

Moreover, the target to be detected by the proximity sensor is not limited to people. The proximity sensor can detect vehicles such as automobiles. For example, the proximity sensor may be placed in a parking lot, for example, to check vehicle occupancy.

Note that since the above embodiment is provided to illustrate an example of the techniques of the present disclosure, various modifications, permutations, additions and omissions are possible within the scope of the appended claims and equivalents thereof.

### INDUSTRIAL APPLICABILITY

Since the proximity sensor according to the present disclosure can be made compact and is capable of detecting a target object with reduced influence from nearby non-target objects, it is applicable in various systems such as window sensors.

What is claimed is:

1. A proximity sensor, comprising:
a substrate;
a first shield electrode disposed on a front surface of the substrate;
a first detection electrode disposed on the front surface of the substrate, in a region surrounding the first shield electrode, the first detection electrode being electrically insulated from the first shield electrode and having an outer perimeter that is polygonal;
a drive unit supplied with power, connected to the first shield electrode and the first detection electrode, and configured to apply voltage that equalizes an electric potential of the first shield electrode and an electric potential of the first detection electrode; and
a detection unit configured to detect a change in capacitance in the first detection electrode.

2. The proximity sensor according to claim 1, further comprising a second shield electrode disposed on a rear surface of the substrate opposite the front surface of the substrate.

3. The proximity sensor according to claim 2, wherein in a plan view of the front surface of the substrate, the second shield electrode does not extend beyond the outer perimeter of the first detection electrode.

4. The proximity sensor according to claim 1, wherein the outer perimeter of the first detection electrode is rectangular.

5. The proximity sensor according to claim 1, wherein the first shield electrode covers a region inside an inner perimeter of the first detection electrode.

6. The proximity sensor according to claim 1, wherein
the first detection electrode comprises one or more first detection electrodes and the first shield electrode comprises one or more first shield electrodes, and
among the one or more first detection electrodes and the one or more first shield electrodes, an outermost electrode is the first detection electrode.

7. The proximity sensor according to claim 6, wherein
the first detection electrode comprises a plurality of first detection electrodes, and
a first shield electrode among the one or more first shield electrodes is disposed in a region surrounding a first detection electrode among the plurality of first detection electrodes.

8. A proximity sensor, comprising:
a substrate;
a first shield electrode disposed on a front surface of the substrate;
a first detection electrode disposed on the front surface of the substrate, in a region surrounding the first shield electrode, the first detection electrode being electrically insulated from the first shield electrode;
a second detection electrode disposed on the front surface of the substrate, inside a perimeter of the first detection electrode, the second detection electrode being electrically insulated from the first shield electrode and the first detection electrode;
a drive unit supplied with power, connected to the first shield electrode, the first detection electrode, and the second detection electrode, and configured to apply voltage that equalizes an electric potential of the first shield electrode, an electric potential of the first detection electrode, and an electric potential of the second detection electrode; and
a detection unit configured to detect a change in capacitance in the first detection electrode and the second detection electrode.

9. The proximity sensor according to claim 8, further comprising a second shield electrode disposed on a rear surface of the substrate opposite the front surface of the substrate.

10. The proximity sensor according to claim 9, wherein in a plan view of the front surface of the substrate, the second shield electrode does not extend beyond the outer perimeter of the first detection electrode.

11. The proximity sensor according to claim 8, wherein the outer perimeter of the first detection electrode is rectangular.

12. The proximity sensor according to claim 8, wherein the first shield electrode covers a region inside an inner perimeter of the first or second detection electrode disposed in the region surrounding the first shield electrode.

13. The proximity sensor according to claim 8, wherein
the first detection electrode comprises one or more first detection electrodes, the second detection electrode comprises one or more second detection electrodes, and the first shield electrode comprises one or more first shield electrodes, and
among the one or more first detection electrodes, one or more second detection electrodes, and the one or more first shield electrodes, an outermost electrode is the first detection electrode.

14. The proximity sensor according to claim 13, wherein
at least one of the first detection electrode and the second detection electrode comprises a plurality of detection electrodes, and
a first shield electrode among the one or more first shield electrodes is disposed in a region surrounding a detection electrode among the plurality of detection electrodes.
